(19) United States
(12) Patent Application Publication
(10) Pub. No.: US 2023/0381054 A1
(43) Pub. Date: Nov. 30, 2023

(54) TACTILE SENSE PRESENTATION DEVICE, TACTILE SENSE PRESENTATION METHOD, RECORDING MEDIUM, AND ELECTRONIC DEVICE

(71) Applicant: ROHM CO., LTD., Kyoto (JP)

(72) Inventor: Takashi NAIKI, Kyoto (JP)

(73) Assignee: ROHM CO., LTD., Kyoto (JP)

(21) Appl. No.: 18/322,050

(22) Filed: May 23, 2023

(30) Foreign Application Priority Data
May 25, 2022 (JP) 2022-085120

(51) Int. Cl. A61H 3/06

(52) U.S. Cl. CPC A61H 3/068; A61H 2003/063; A61H 23/0245

(57) ABSTRACT

A tactile sense presentation device includes: an object information acquisition part configured to acquire, as a state of an object, object information related to at least one selected from the group of a position, a direction, a distance, a speed, an acceleration, and urgency; and a tactile stimulus presentation part configured to present the state of the object as a tactile stimulus in a pseudo manner based on the object information.

### CROSS-REFERENCE TO RELATED APPLICATION

This application is based upon and claims the benefit of priority from Japanese Patent Application No. 2022-085120, filed on May 25, 2022, the entire contents of which are incorporated herein by reference.

### TECHNICAL FIELD

The present disclosure relates to a tactile sense presentation device, a tactile sense presentation method, a tactile sense presentation program, and an electronic device.

### BACKGROUND

In the related art, devices that present surrounding conditions, such as the existence of an object, to a user through a voice or a tactile sense have been developed.

For example, there is a known electronic white cane system in which a computer analyzes measured values sent from sensors, estimates a surrounding situation, and communicates the estimation result to a user by a voice or a tactile sense.

However, in the related art, when the surrounding situation is presented by a voice, there is a problem that it is difficult to use the electronic white cane system in an environment in which extraneous noise is of a concern, a use environment that is vulnerable to lack of sound information due to competition with other sounds, a case where the user is hard of hearing, and the like.

On the other hand, in the related art, when the surrounding situation is presented by a tactile sense, there is a problem that the tactile sense presentation method is not intuitive, which makes it difficult to recognize the surrounding situation. For example, in the related art, a vibrator that conveys the existence of a wall, a vibrator that conveys the existence of a stair, and a vibrator that conveys the existence of a step are arranged around a grip of the electronic white cane. However, there is a problem that it is difficult for the user to intuitively recognize a positional relationship of objects and the like in real time.

### SUMMARY

Some embodiments of the present disclosure provide a tactile sense presentation device, a tactile sense presentation method, and a tactile sense presentation program, which allow a user to intuitively recognize a surrounding situation with a tactile sense even when it is difficult to convey the surrounding situation visually or aurally.

According to one embodiment of the present disclosure, a tactile sense presentation device includes: an object information acquisition part configured to acquire, as a state of an object, object information related to at least one selected from the group of a position, a direction, a distance, a speed, an acceleration, and urgency; and a tactile stimulus presentation part configured to present the state of the object as a tactile stimulus in a pseudo manner based on the object information.

According to another embodiment of the present disclosure, a tactile sense presentation method includes: acquiring, as a state of an object, object information related to at least one selected from the group of a position, a direction, a distance, a speed, an acceleration, and urgency; and presenting the state of the object as a tactile stimulus in a pseudo manner based on the object information.

According to another embodiment of the present disclosure, an electronic device is equipped with the tactile sense presentation device.

### BRIEF DESCRIPTION OF DRAWINGS

The accompanying drawings, which are incorporated in and constitute a part of the specification, illustrate embodiments of the present disclosure.

FIG. 1 is a block diagram showing an example of a configuration of a tactile sense presentation system including a tactile sense presentation device according to an embodiment.

FIG. 2 is a diagram showing an example in which the embodiment is applied to a white cane.

FIG. 3 is a diagram showing an example in which the embodiment is applied to a white cane.

FIG. 4 is a diagram showing an example in which the embodiment is applied to a white cane.

FIG. 5 is a diagram showing a surface on which tactile elements are arranged.

FIG. 6 is a diagram showing an example in which the tactile elements are arranged in a wider range than in FIG. 5.

FIG. 7 is a diagram in which the embodiment is applied to a seat surface of a driver's seat of a vehicle.

FIG. 8 is a plan view showing a transducer of the embodiment.

FIG. 9 is a cross-sectional view showing the transducer of the embodiment.

FIG. 10 is a plan view showing an arrangement of vibration membranes on a main surface of a substrate of the transducer.

FIG. 11 is a diagram showing a movable protrusion that uses an electromagnetic solenoid as the tactile element.

FIG. 12 is a flowchart showing an example of a tactile sense presentation process in the tactile sense presentation device of the embodiment.

FIG. 13 is a diagram showing examples of a tactile stimulus pattern according to a state of an object.

FIG. 14 is a diagram showing vibration modes in one vibration stimulation section (rectangle on the second row in FIG. 14) during a vibration period shown in FIG. 13.

FIG. 15 is a diagram showing vibration modes in one vibration stimulation section (rectangle on the second row in FIG. 14) during the vibration period shown in FIG. 13.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Next, the present embodiment will be described with reference to the drawings. In the description of the drawings described below, the same or similar parts are denoted by the same or similar reference numerals. However, it should be noted that the drawings are schematic, and a relationship between a thickness of each component and a plane dimensions, etc. differs from an actual one. Therefore, specific thicknesses and dimensions should be determined with reference to the following description. In addition, it goes without saying that there are portions with different dimensional relationships and ratios between the drawings.

Further, the embodiment shown below is an example for embodying technical ideas, and does not specify a material, shape, structure, arrangement, etc. of each component. Various modifications may be made to the embodiment based on the configurations defined in the claims.

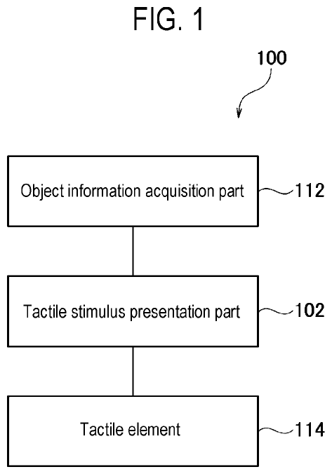

Hereinafter, a configuration of the present embodiment will be described first, and then a process and the like of the present embodiment will be described in detail. FIG. 1 is a block diagram showing an example of a configuration of a tactile sense presentation system including a tactile sense presentation device 100 according to the present embodiment. FIG. 1 conceptually shows only portions of the configuration related to the present embodiment.

### [Configuration of Tactile Sense Presentation Device]

As shown in FIG. 1, the tactile sense presentation system including the tactile sense presentation device 100 according to the present embodiment is configured by connecting an object information acquisition part 112, a tactile stimulus presentation part 102, and a tactile element 114 by wire or wirelessly. In other words, the tactile sense presentation device 100 includes at least the object information acquisition part 112 and the tactile stimulus presentation part 102. In addition, the respective parts may be configured to be communicably connected via an arbitrary communication path.

Among the parts, the object information acquisition part 112 acquires object information regarding at least one of a position, direction, distance, speed, acceleration, and urgency as a state of an object. For example, the object information acquisition part 112 may be a sensor or the like (e.g., a 3D camera, or a LiDAR (light detection and ranging)) configured to acquire object information by detecting (sensing) at least one of the position, direction, distance, speed, and acceleration of the object. Further, the object information acquisition part 112 may acquire object information via an arbitrary communication path. For example, the object information acquisition part 112 may acquire object information by wire or wirelessly from an external system such as an obstacle detection system installed in a vehicle.

In addition, the object information acquisition part 112 may acquire object information regarding the urgency of the object by determining the urgency based on at least one of the position, direction, distance, speed, and acceleration of the object. For example, the object information acquisition part 112 may determine the urgency based on that the position and distance of the object are within a threshold value range, the object moves toward a user, the speed and acceleration of the object are equal to or higher than threshold values, or the like. Alternatively, the object information acquisition part 112 may acquire object information regarding the urgency from an external system such as an obstacle detection system installed on a vehicle. Further, the speed and acceleration of the object are not limited to an absolute speed and an absolute acceleration, and may be a relative speed and a relative acceleration when the user is moving.

In addition, the tactile stimulus presentation part 102 presents a state of the object as a tactile stimulus in a pseudo manner based on the object information acquired by the object information acquisition part 112. In other words, the tactile stimulus presentation part 102 simulates the position, direction, distance, speed, acceleration, urgency, and the like of the object to generate tactile stimuli and presents them to the user. In one form of the present embodiment, tactile elements 114, which are arranged in an array, plane, or line and present a vibration or a pressure (including an electrical stimulus), are provided on a surface on which the tactile stimulus is presented. By appropriately controlling the tactile elements 114, the tactile stimulus presentation part 102 stimulates a plurality of tactile receptors on the user's skin surface to intuitively communicate the position, direction, distance, speed, acceleration, urgency, and the like of the object.

For example, the tactile stimulus presentation part 102 may present the direction or distance of the object in a pseudo manner by positions of controlling the tactile elements 114. Specifically, the tactile stimulus presentation part 102 performs control to apply stimuli to positions on the user's skin surface corresponding to the tactile receptors such that the direction or distance of the object is expressed.

In addition, the tactile stimulus presentation part 102 may present the distance, urgency, and relative speed of the object in a pseudo manner by intensity of controlling the tactile elements 114. Specifically, the tactile stimulus presentation part 102 performs control to stimulate the tactile receptors on the user's skin surface at an appropriate intensity such that the distance, urgency, and relative speed of the object are expressed.

In addition, the tactile stimulus presentation part 102 may present the distance, urgency, and relative speed of the object in a pseudo manner by a frequency of controlling the tactile elements 114. Specifically, the tactile stimulus presentation part 102 performs control to stimulate the tactile receptors on the user's skin surface at an appropriate frequency such that the distance, urgency, and relative speed of the object are expressed.

In addition, the tactile stimulus presentation part 102 may present the distance, urgency, and relative speed of the object in a pseudo manner by moving the positions of controlling the tactile elements 114. Specifically, the tactile stimulus presentation part 102 performs control to stimulate the tactile receptors on the user's skin surface at appropriate positions such that the distance, urgency, and relative speed of the object are expressed.

The tactile stimulus presentation part 102 may arbitrarily combine two or more control methods of simulating the position, direction, distance, speed, acceleration, urgency, and the like of the object as exemplified above.

In addition, the tactile stimulus presentation part 102 may set an origin (an asterisk, which will be described later with reference to the drawings) indicating a pseudo position of the user in the array, plane, or line on which the tactile elements 114 are arranged, and may present the state of the object relative to the position of the user as a control position relative to the origin. Specifically, the tactile stimulus presentation part 102 may set an origin on the user's skin surface, which is an imaginary position of the user, and then may perform control to stimulate tactile receptors having positions, directions, distances, and the like relative to the origin on the user's skin surface, which correspond to the position, direction, distance, and the like of the object.

In addition, in order to present urgency, the tactile stimulus presentation part 102 may control a larger number of tactile elements 114 than in non-emergency. In addition, the tactile stimulus presentation part 102 may perform control in which vibrators of the tactile elements 114 are turned off when presenting a non-tactile stimulus and are turned on when presenting a tactile stimulus, or vice versa (the vibrators are turned on when presenting a non-tactile stimulus and are turned off when presenting a tactile stimulus). Similarly, the tactile stimulus presentation part 102 may perform control in which the movable protrusions of the tactile elements 114 are retracted when presenting a non-tactile stimulus and are caused to protrude when presenting a tactile stimulus, or vice versa (the movable protrusions are caused to protrude when presenting a non-tactile stimulus and are retracted when presenting a tactile stimulus).

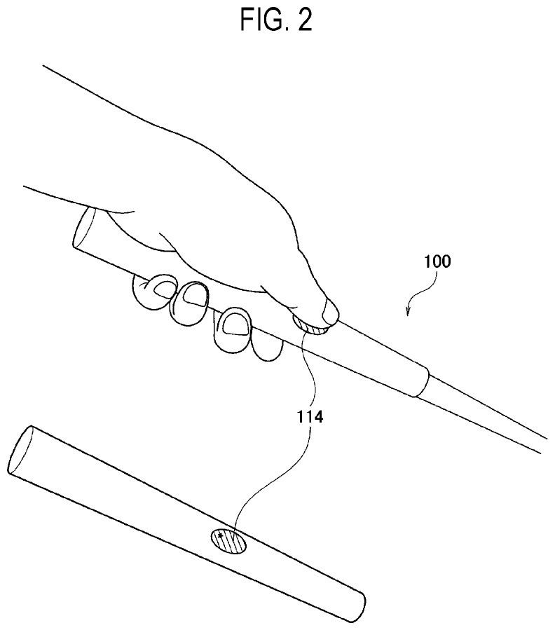

Here, the tactile elements 114 are members or the like (such as actuators) controlled by the tactile stimulus presentation part 102 to present a tactile stimulus such as a vibration or a pressure (including an electrical stimulus). In the description made herein, the term “tactile element 114” is not limited to a single element, but may also refer to a plurality of elements. In particular, in the present embodiment, a plurality of tactile elements 114 is arranged in an array, plane, or line to present a vibration or a pressure (including an electrical stimulus). For example, one unit of the vibrator of the tactile element 114 may consist of a unitary structure or an array structure of piezoelectric bodies (piezoelectric elements). Further, the vibrator of the tactile element 114 may be a voice coil type vibrator, a piezo element, a vibration motor, or the like. Here, FIGS. 2 to 4 are diagrams showing a white cane, which is an example of an electronic device equipped with the tactile sense presentation device 100.

As shown in FIGS. 2 to 4, there are multiple methods to hold the white cane. Therefore, it is devised so that a tactile stimulus is intuitively presented to the user according to a method of holding the white cane. Since a surface of the tactile element 114 (hatched portion) from which the tactile stimulus is presented may be hidden by the hand, each drawing is also accompanied by a figure that depicts a case where the white cane is not held by the hand.

FIG. 2 shows a method of holding the white cane and a position of the tactile element 114 (hatched portion) when performing a slide technique or a touch technique. As shown in FIG. 2, in this holding method, the user's virtual origin (asterisk) is set at a root of a thumb, and a tactile stimulus as a moving direction of the user is expressed at a tip of the thumb.

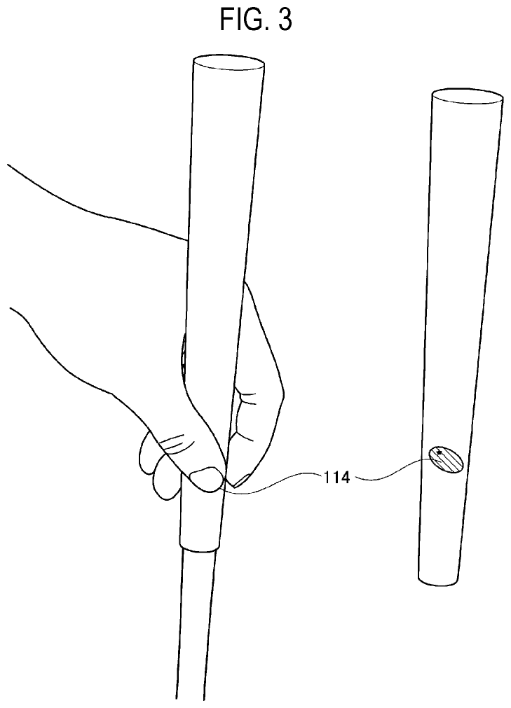

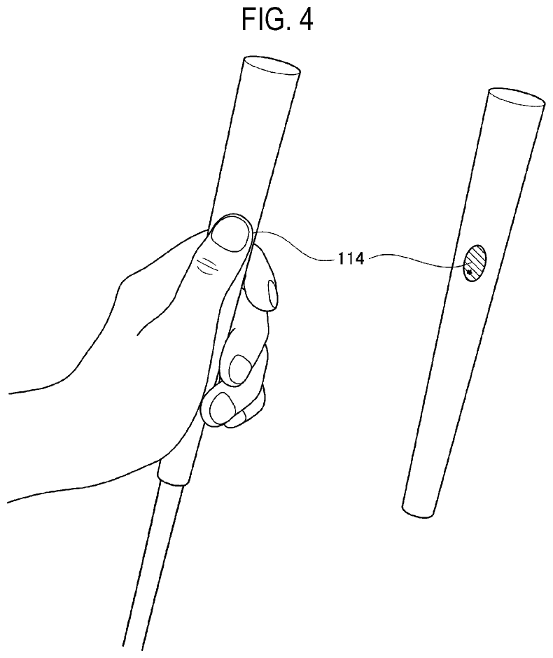

FIGS. 3 and 4 show a method of holding the white cane, called pencil holding, and a position of the tactile element 114 (hatched portion). As shown in FIGS. 3 and 4, the user's virtual origin (asterisk) is set at the root of the thumb, and the tactile stimulus as the moving direction of the user is expressed at the tip of the thumb.

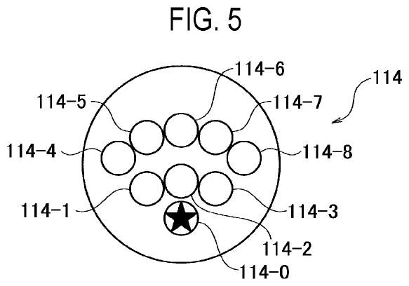

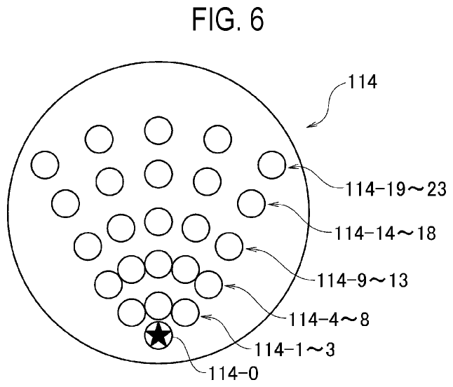

FIGS. 5 and 6 are diagrams showing the surface on which the tactile elements 114 are arranged. Although one unit of the tactile element 114 is depicted by a small circle, this small circle is not limited to one element (such as a piezoelectric element or the like). As will be described later, a plurality of elements may constitute one unit of the tactile element 114 (e.g., MEMS (Micro Electro Mechanical Systems)).

As described above, the asterisks in FIGS. 5 and 6 indicate the origin. Therefore, when the object is moving toward the user directly in front of the user, the tactile stimulus presentation part 102 sequentially controls the tactile element 114-6, the tactile element 114-2, and the like. Similarly, when the object is moving toward the user from the front left side of the user, the tactile stimulus presentation part 102 sequentially controls the tactile element 114-4, the tactile element 114-1, and the like. In addition, the tactile stimulus presentation part 102 may control the tactile element 114-0 of the origin so as to be repeatedly turned on and off in order to indicate a position of the origin to the user.

FIG. 6 is a diagram showing an example in which the tactile elements 114 are arranged in a wider range than in FIG. 5. By arranging the tactile elements 114 in such a wide range, it is possible to express a wider range, a long distance, or the like with a tactile sense. In addition, a degree of freedom in tactile expression of speed and acceleration is expanded. For example, when the object is moving toward the user from the front right side of the user, the tactile stimulus presentation part 102 can more finely and precisely express the speed and acceleration by sequentially controlling the tactile elements 114-23, 114-18, 114-13, 114-8, and 114-3.

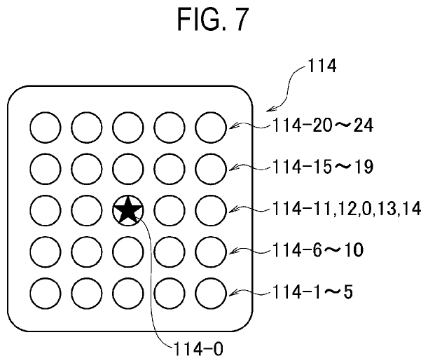

Here, FIG. 7 is a diagram showing an example in which the tactile sense presentation device 100 is mounted on a vehicle (specifically, a seat surface of a driver's seat), which is an example of an electronic device. In this case, the driver can recognize the state of the object by tactile stimuli to the buttocks and thighs. Here, an explanation will be made with an upper side of the drawing as a traveling direction of the vehicle. As shown in FIG. 7, the origin is set near a center of the seat surface. Therefore, the user (driver) can recognize the state of the object behind the vehicle. In particular, there is an additional advantage that it is easier to recognize an obstacle (objects) behind the vehicle when driving backward.

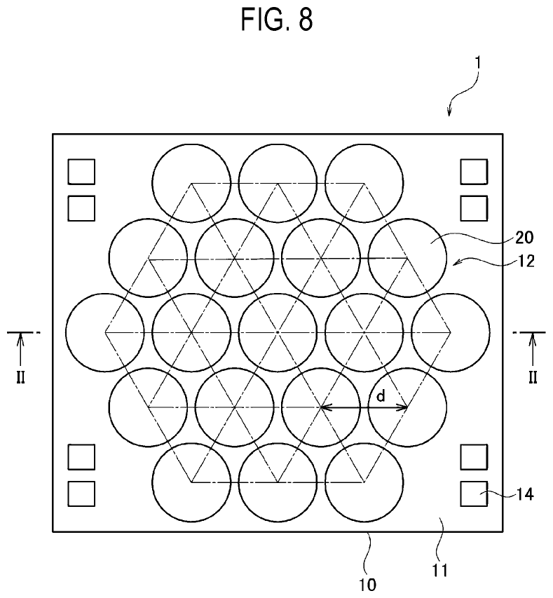

Now, with reference to FIGS. 8 to 10, an example in which one unit of the tactile element 114 described above (small circle in FIGS. 5 to 7) is composed of a plurality of elements as MEMS will be described.

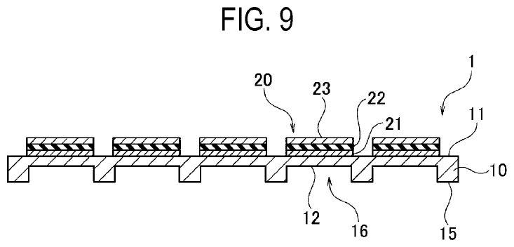

FIG. 8 is a plan view showing a transducer 1 of the present embodiment. FIG. 9 is a cross-sectional view showing the transducer 1 of the present embodiment. The cross-sectional view of FIG. 9 shows a cross-section taken along line II-II in the plan view of FIG. 8. The transducer 1 of the present embodiment is formed on a substrate 10 having a flat main surface 11 and a back surface 15 opposite the main surface 11. The substrate 10 is a substantially plate-shaped silicon substrate having a predetermined thickness, and has a substantially rectangular shape with substantially equal sizes in a vertical direction and a horizontal direction in a plan view. In addition, the substrate 10 is not limited to the silicon substrate, and may be made of other types of materials such as a glass substrate, an organic material, and the like.

A plurality of recesses 16 is formed on the back surface 15 of the substrate 10. The recesses 16 are formed to reach a predetermined depth from the main surface 11, and leaves a predetermined thickness of the substrate 10 so that the main surface 11 can vibrate in a thickness direction of the substrate 10. A plurality of vibration membranes 12 is formed in portions where the predetermined thickness of the substrate 10 is left. Since the vibration membranes 12 are used to generate ultrasonic waves, a natural frequency thereof is set to be higher than the audible range. In addition, in the substrate 10 forming the vibration membranes 12, the main surface 11 is connected along the entire circumference of each vibration membrane 12. However, appropriate slits may be formed in the substrate 10 so that the vibration membranes 12 have a cantilever structure or a doubly-supported structure.

In each of the vibration membranes 12, a drive layer 20 configured by sandwiching a piezoelectric layer 22 between a pair of electrode layers, i.e., a lower electrode layer 21 and an upper electrode layer 23, is stacked on the main surface 11. The drive layer 20 constitutes a piezoelectric element that drives the vibration membrane 12 to vibrate in the thickness direction of the substrate 10 by a voltage supplied via a wiring layer (not shown). In the main surface 11, the vibration membranes 12 have a substantially disk-like shape with a same diameter. In the main surface 11, the drive layers 20 stacked on the vibration membranes 12 also have a substantially disk-like shape conforming to the shape of the vibration membranes 12.

The vibration membranes 12 are arranged on the main surface 11 at equal intervals d in three directions. Here, the interval d between the vibration membranes 12 refers to a distance between respective centers of the vibration membranes 12 having a substantially disk-like shape. In general, the interval d between the vibration membranes 12 may be a distance between centers of gravity of the vibration membranes 12 on the main surface 11. Since the vibration membranes 12 are arranged at equal intervals d in three directions on the main surface 11, there is a symmetry in which other vibration membranes 12 adjacent to one vibration membrane 12 are arranged at six rotationally symmetric positions around the one vibration membrane 12. The equal interval d is not limited to strictly the same interval, and may be substantially the same interval which includes a case where, for example, an error falls within a range of about ±10%.

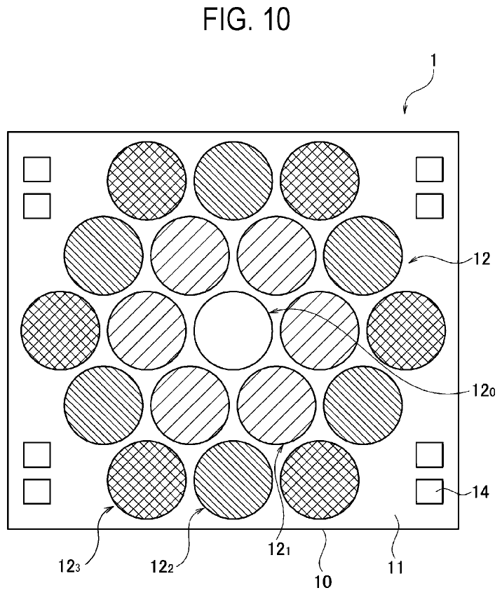

FIG. 10 is a plan view showing an arrangement of the vibration membranes 12 on the main surface 11 of the substrate 10 of the transducer 1. One vibration membrane 12 arranged at a center of the main surface 11 is called a central vibration membrane 12₀. The vibration membranes 12 includes six vibration membranes 12 located adjacent to the central vibration membrane 12₀. The six vibration membranes 12 are arranged at predetermined intervals along a circumference spaced apart by a predetermined distance from the central vibration membrane 12₀ so as to surround the central vibration membrane 12₀. These six vibration membranes 12 will be referred to as first circumference vibration membranes 12₁.

In addition, the vibration membranes 12 includes twelve vibration membranes 12 arranged to surround the first circumference vibration membranes 12₁ such that six vibration membranes 12 are arranged at six rotationally symmetric positions along each of two adjacent circumferences with respect to the first circumference vibration membranes 12₁. Among these twelve vibration membranes 12, six vibration membranes 12 having a relatively small distance from the central vibration membrane 12₀ will be referred to as second circumference vibration membranes 12₂, and six vibration membranes 12 having a relatively large distance from the central vibration membrane 12₀ will be referred to as third circumference vibration membranes 12₃.

The second circumference vibration membranes 12₂ are arranged at predetermined intervals along a circumference spaced apart by a predetermined distance from the central vibration membrane 12₀ so as to surround the first circumference vibration membranes 12₁. The third circumference vibration membranes 12₃ are arranged at predetermined intervals along a circumference spaced apart by a predetermined distance from the central vibration membrane 12₀ so as to surround the second circumference vibration membranes 12₂. Most of the main surface 11 is occupied by the central vibration membrane 12₀, the first circumference vibration membranes 12₁, the second circumference vibration membranes 12₂, and the third circumference vibration membranes 12₃.

In portions near four vertices of the main surface 11 having a substantially rectangular shape in a plan view and where the vibration membranes 12 are not arranged, a plurality of electrode pads 14 is formed along a pair of sides extending in a longitudinal direction of the main surface 11. Wirings (not shown) are connected from the electrode pads 14 to the pair of electrode layers, i.e., the lower electrode layer 21 and the upper electrode layer 23, of the drive layer 20 so that a voltage can be supplied to the drive layers 20 that respectively drive the vibration membranes 12. A common wiring is connected from the electrode pads 14 to the drive layers 20.

In addition, the connection of the wirings extending from the pair of electrode pads 14 to the drive layers 20 is not limited to that described above. The wirings may be independently connected so that some of the vibration membranes 12 formed on the main surface 11 are individually controlled. For example, a common wiring extending to the drive layers 20 for driving the vibration membranes 12 may be provided for each of the central vibration membrane 12₀, the first circumference vibration membranes 12₁, the second circumference vibration membranes 12₂, and the third circumference vibration membranes 12₃, which are arranged on the main surface 11, and may be connected so as to independently drive the central vibration membrane 12₀, the first circumference vibration membranes 12₁, the second circumference vibration membranes 12₂, and the third circumference vibration membranes 12₃. Alternatively, wiring extending to the drive layers 20 for driving the vibration membranes 12 may be provided independently for each of the vibration membranes 12 arranged on the main surface 11, and may be connected so that the vibration membranes 12 can be driven individually. By independently controlling at least a part of the vibration membranes 12 formed on the main surface 11, it is possible to provide various functions such as, for example, causing sound waves generated in different phases to interfere mutually.

In the transducer 1 of the present embodiment, by arranging the substantially disk-shaped vibration membranes 12 having the same diameter on the main surface 11 at equal intervals d in three directions, most of the main surface 11 is occupied by the vibration membranes 12. With such an arrangement, other vibration membranes 12 adjacent to one vibration membrane 12 are arranged at six rotationally symmetric positions, which makes it possible to arrange the vibration membranes 12 at a high density. Therefore, most of the main surface 11 is effectively utilized as the vibration membranes 12, and the transducer 1 can generate sufficient vibration for the transducer 1 to be used as a tactile element. In addition, since the transducer 1 of the present embodiment is manufactured by using a MEMS technique to which a semiconductor manufacturing technique is applied, a plurality of individual pieces can be manufactured at once with high accuracy.

In the transducer 1 of the present embodiment, the vibration membranes 12 are arranged on the main surface 11 at equal intervals in three directions. However, the present disclosure is not limited thereto. The vibration membranes 12 may be arranged on the main surface 11 at equal intervals in two directions. Even in such a case, the density of the vibration membranes 12 on the main surface 11 can be secured, and the vibration membranes 12 can be formed on most of the main surface 11.

In the transducer 1 of the present embodiment, the vibration membranes 12 are composed of the central vibration membrane 12₀, the first circumference vibration membranes 12₁, the second circumference vibration membranes 12₂, and the third circumference vibration membranes 12₃. However, the present disclosure is not limited thereto. The vibration membranes 12 may be composed of vibration membranes 12 arranged on a desired number of circumferences from the central vibration membrane 12₀. By repeatedly arranging vibration membranes 12 constituting one circumference (n-th circumference, where n=1, 2, 3, . . . ) and vibration membranes 12 constituting a subsequent circumference ((n+1)-th circumference) adjacent to the one circumference, the vibration membranes 12 can be arranged on a desired number of circumferences.

In the present embodiment, the vibration membranes 12 arranged on the main surface 11 have a substantially disk-like shape with the same diameter. However, the present disclosure is not limited thereto. For example, the vibration membranes 12 may have the same predetermined shape, at least some of the vibration membranes 12 may have the same shape, or all of the vibration membranes 12 may have different shapes. In addition, the vibration membranes 12 forming the same circumference, for example, the central vibration membrane 12₀, the first circumference vibration membranes 12₁, the second circumference vibration membranes 12₂, and the third circumference vibration membranes 12₃, may have the same shape, respectively. For example, the central vibration membrane 12₀, the first circumference vibration membranes 12₁, the second circumference vibration membranes 12₂, and the third circumference vibration membranes 12₃ may have substantially disk-like shapes with different diameters. Since the drive layers 20 are stacked on the vibration membranes 12, each of the drive layers 20 may have the same shape as that of the vibration membrane 12 on which the drive layer 20 is stacked.

As described above, one unit of the tactile element 114 (the small circle in FIGS. 5 to 7) is composed of a plurality of elements as MEMS, whereby various functions can be achieved. For example, by independently controlling at least a part of the vibration membranes 12 formed on the main surface 11, it is possible to provide various functions such as, for example, causing sound waves generated in different phases to interfere mutually. For example, during vibration, by delaying a phase of a vibration waveform in the central portion (12₀) relatively to the peripheral portions (12₂ and 12₁), it is possible to concentrate emitted ultrasonic waves on the central portion and to form beam forming, whereby a strong tactile stimulus can be presented. In addition, by adjusting phase relationships of drive waves based on the same principle as changing a direction of interfering waves, it is possible to perform control to move a location where the ultrasonic waves are concentrated. For example, by moving around the location where the ultrasonic waves are concentrated, a more appealing tactile stimulus can be presented.

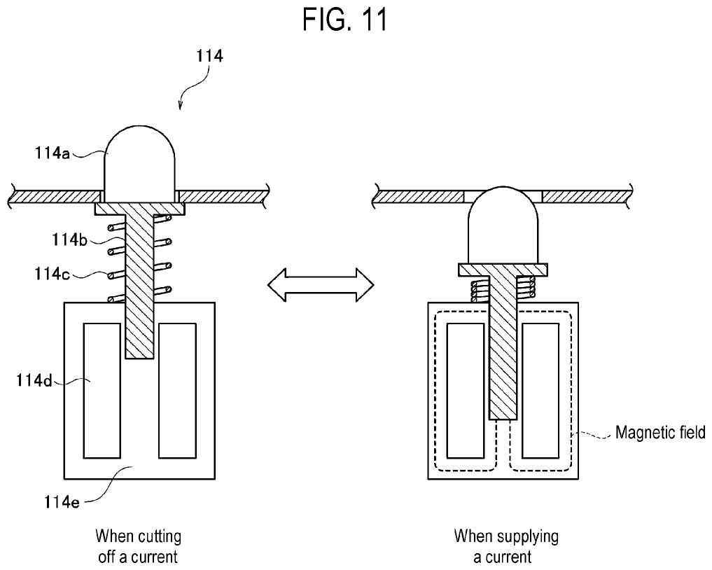

In the above-described example, the case where the tactile element 114 is a vibrator has been mainly described by way of example. However, the tactile element 114 may be a movable protrusion using an electromagnetic solenoid or the like. FIG. 11 is a diagram showing a movable protrusion using an electromagnetic solenoid as the tactile element 114.

As shown in FIG. 11, a fixed iron core 114e and a movable iron core 114b are provided. When flowing a current through the coil 114d, a magnetic field is generated. Therefore, the movable iron core 114b is attracted into the fixed iron core 114e, and a movable protrusion 114a is retracted. When the current is cut off, by a force (load) of a return spring 114c, the movable iron core 114b returns to its original position and the movable protrusion 114a protrudes. This is an operating principle of a linear electromagnetic solenoid.

The description of each configuration of the tactile sense presentation device 100 of the present embodiment is completed as above.

### [Process Performed by Tactile Sense Presentation Device 100]

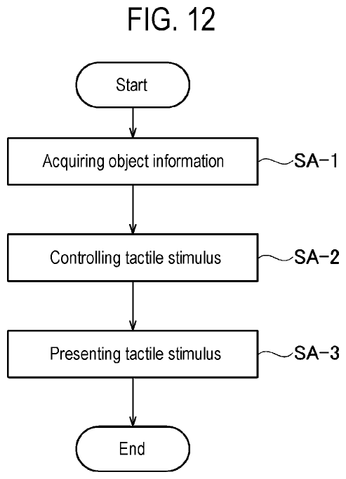

Next, an example of a process performed by the tactile sense presentation device 100 according to the present embodiment configured as described above will be described in detail below with reference to FIGS. 12 to 15. FIG. 12 is a flowchart showing an example of a tactile sense presentation process performed by the tactile sense presentation device 100 of the present embodiment.

As shown in FIG. 12, first, the object information acquisition part 112 of the tactile sense presentation device 100 acquires object information related to at least one of a position, direction, distance, speed, acceleration, and urgency as an object state (step SA-1). For example, the object information acquisition part 112 may detect a position, direction, distance, speed, and acceleration of an object by using a sensor such as LiDAR or the like, or may acquire object information by determining urgency based on the acquired object state (speed, direction, etc.)

Based on the object information acquired by the object information acquisition part 112, the tactile stimulus presentation part 102 transmits a signal (electric signal, etc.) that controls the tactile element 114 so that the object state is presented as a tactile stimulus in a pseudo manner (step SA-2).

Thereafter, the tactile element 114 is driven according to the signal transmitted from the tactile stimulus presentation part 102, thereby presenting the object state as a tactile stimulus in a pseudo manner (step SA-3).

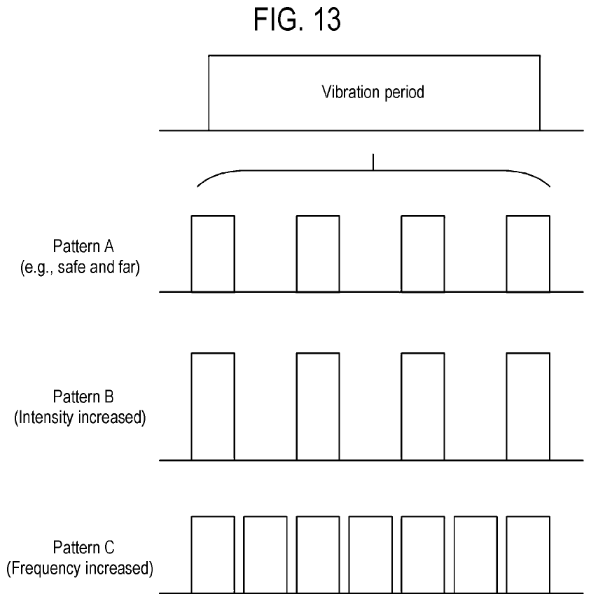

FIG. 13 is a diagram showing examples of a tactile stimulus pattern according to a state of an object. The horizontal axis in FIG. 13 is a time axis, and the vertical axis in FIG. 13 represents a magnitude of vibration. As shown in FIG. 13, when a position of the object is far from the user or when the speed is safe, the tactile stimulus presentation part 102 presents a relatively small vibration stimulus with a relatively long vibration period (Pattern A).

On the other hand, when the position of the object is close to the user, or when the urgency is high, such as a dangerous speed, the tactile stimulus presentation part 102 presents a tactile stimulus in pattern B that presents a relatively large vibration stimulus, or in pattern C in which the vibration period (frequency) is relatively long.

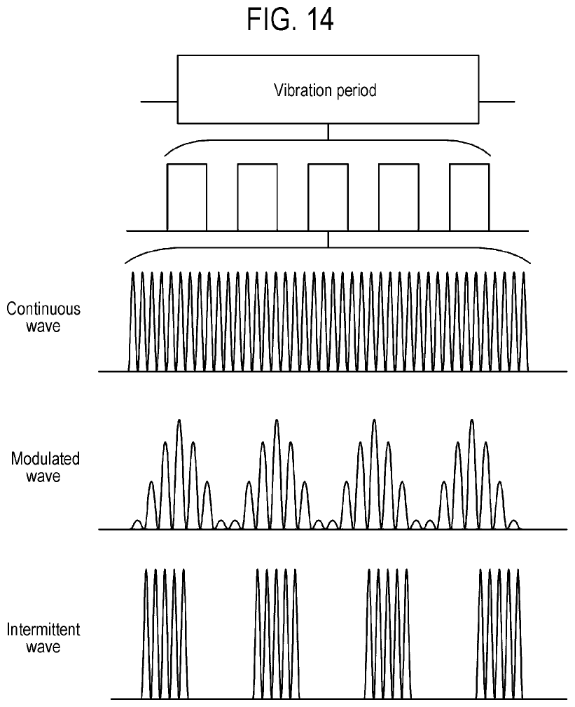

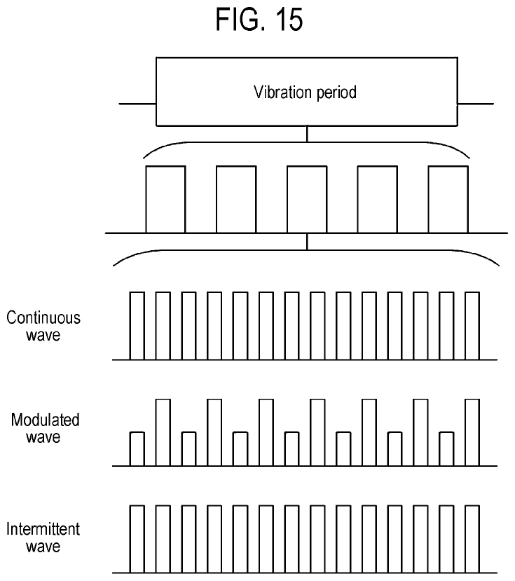

FIGS. 14 and 15 are diagrams showing modes of vibration in one vibration stimulation section (the rectangle in the second row of FIG. 14) during the vibration period shown in FIG. 13. As shown in FIG. 14, in one vibration stimulation section, the tactile stimulus presentation part 102 may present a tactile stimulus as a continuous wave, as a modulated wave, or as an intermittent wave. In addition, as shown in FIG. 15, even in a case of a pressure stimulus such as a movable protrusion, the tactile stimulus presentation part 102 may present a tactile stimulus as a continuous wave, as a modulated wave, or as an intermittent wave. These stimulus patterns have shapes and strengths of stimuli that are easily perceived by people. Therefore, the tactile stimulus presentation part 102 of the tactile sense presentation device 100 may be configured to be adjustable and selectable.

The above is an example of the process performed by the tactile sense presentation device 100.

The specific tactile sense presentation device and tactile sense presentation method of the present embodiment are as follows.

<1> A tactile sense presentation device including: an object information acquisition part configured to acquire, as a state of an object, object information related to at least one selected from the group of a position, a direction, a distance, a speed, an acceleration, and urgency; and a tactile stimulus presentation part configured to present the state of the object as a tactile stimulus in a pseudo manner based on the object information.

According to <1>, even when it is difficult to convey a surrounding situation visually or aurally, the user can intuitively recognize the surrounding situation with a tactile sense.

<2> The tactile sense presentation device of <1>, wherein the tactile stimulus presentation part is configured to present the state of the object as a tactile stimulus of vibration sense or pressure sense in a pseudo manner by controlling tactile elements, which are arranged in an array, a plane, or a line and configured to present a vibration or a pressure.

According to <2>, fine tactile stimuli can be reproduced by using the tactile elements arranged in an array, a plane, or a line.

<3> The tactile sense presentation device of <2>, wherein the tactile stimulus presentation part is configured to present the direction or the distance of the object in a pseudo manner by positions of controlling the tactile elements.

According to <3>, the user can intuitively perceive the direction or the distance of the object via tactile receptors.

<4> The tactile sense presentation device of <2>, wherein the tactile stimulus presentation part is configured to present the distance, the urgency, and a relative speed of the object in a pseudo manner by intensity of controlling the tactile elements.

According to <4>, the user can intuitively perceive the distance, the urgency, and the relative speed of the object via tactile receptors.

<5> The tactile sense presentation device of <2>, wherein the tactile stimulus presentation part is configured to present the distance, the urgency, and a relative speed of the object in a pseudo manner by a frequency of controlling the tactile elements.

According to <5>, the user can intuitively perceive the distance, the urgency, and the relative speed of the object via tactile receptors.

<6> The tactile sense presentation device of <2>, wherein the tactile stimulus presentation part is configured to present the distance, the urgency, and a relative speed of the object in a pseudo manner by moving positions of controlling the tactile elements.

According to <6>, the user can intuitively perceive the distance, the urgency, and the relative speed of the object via stimulation positions of tactile receptors.

<7> A tactile sense presentation device obtained by combining at least two of the tactile stimulus presentation parts of the tactile sense presentation device of any one of <3> to <6>.

According to <7>, fine tactile sense presentation can be performed.

<8> The tactile sense presentation device of any one of <2> to <7>, wherein the tactile stimulus presentation part is configured to set an origin indicating a pseudo position of a user in the array, the plane, or the line on which the tactile elements are arranged, and present the state of the object relative to the position of the user as a control position relative to the origin.

According to <8>, the user can intuitively perceive the distance, the direction, and the like of the object through stimulation positions of the tactile receptors with respect to the origin.

<9> The tactile sense presentation device of any one of <2> to <8>, wherein the tactile stimulus presentation part is configured to control, when presenting the urgency, a larger number of tactile elements than in a non-emergency.

According to <9>, the user can intuitively perceive the urgency of the object through a stimulation range of the tactile receptors.

<10> The tactile sense presentation device of any one of <2> to <9>, wherein one unit of a vibrator of each of the tactile elements has a single piezoelectric body structure or a piezoelectric body array structure.

According to <10>, one or a plurality of piezoelectric elements or the like can be used to present tactile stimuli of various intensities.

<11> The tactile sense presentation device of any one of <2> to <10>, wherein the tactile stimulus presentation part is configured to perform control of turning vibrators of the tactile elements off when presenting a non-tactile stimulus and turning vibrators of the tactile elements on when presenting a tactile stimulus, or control of turning the vibrators of the tactile elements on when presenting a non-tactile stimulus and turning the vibrators of the tactile elements off when presenting a tactile stimulus.

According to <11>, the user can intuitively perceive the state of the object through the presence or absence of stimulation for tactile receptors.

<12> The tactile sense presentation device of any one of <2> to <11>, wherein the tactile elements are movable protrusions using electromagnetic solenoids.

According to <12>, it is possible to present pressure stimuli to tactile receptors.

<13> The tactile sense presentation device of <12>, wherein the tactile stimulus presentation part is configured to perform control of causing the movable protrusions of the tactile elements to retract when presenting a non-tactile stimulus and causing the movable protrusions of the tactile elements to protrude when presenting a tactile stimulus, or control of causing the movable protrusions of the tactile elements to protrude when presenting a non-tactile stimulus and causing the movable protrusions of the tactile elements to retract when presenting a tactile stimulus.

According to <13>, the user can intuitively perceive the distance, the urgency, and the relative speed of the object through the presence or absence of stimulation for tactile receptors.

<14> The tactile sense presentation device of <10>, wherein the tactile stimulus presentation part is configured to, during vibration of the array structure, concentrate emitted ultrasonic waves on a central portion by delaying a phase of a vibration waveform in the central portion with respect to a phase of a vibration waveform in a peripheral portion.

According to <14>, a high-intensity tactile stimulus can be presented by the principle of beamforming.

<15> The tactile sense presentation device of any one of <1> to <14>, wherein the tactile stimulus presentation part is configured to move a location where ultrasonic waves are concentrated, by adjusting a phase relationship between drive waves.

According to <15>, it is possible to present an easy-to-perceive tactile stimulus by sequentially moving stimulation positions.

<16> A tactile sense presentation method, including: acquiring, as a state of an object, object information related to at least one selected from the group of a position, a direction, a distance, a speed, an acceleration, and urgency; and presenting the state of the object as a tactile stimulus in a pseudo manner based on the object information.

According to <16>, even when it is difficult to convey a surrounding situation visually or aurally, the user can intuitively recognize the surrounding situation by a tactile sense.

### OTHER EMBODIMENTS

Although the present embodiment has been described thus far, the present disclosure may be implemented in various different embodiments other than the above-described embodiment within the scope of the technical idea defined in the claims.

For example, the tactile sense presentation device 100 may be configured integrally to perform a process in a stand-alone manner, or may be configured to perform a process in response to a request from a terminal and return the process result to the terminal.

In addition, among the processes described in the embodiment, all or a part of the processes described as being performed automatically may be performed manually, or all or a part of the processes described as being performed manually may be performed automatically by known methods.

In addition, unless otherwise specified, process sequences, control sequences, specific names, information including parameters such as registration data and search conditions for each process, screen examples, and database configurations shown in the above description and the drawings may be changed arbitrarily.

In addition, regarding the tactile sense presentation device 100, each component described with reference to the drawings is functionally conceptual, and does not necessarily have the physical configuration as illustrated in the drawings.

For example, all or any part of processing functions provided by respective components of the tactile sense presentation device 100, particularly, respective processing functions performed by the tactile stimulus presentation part 102, may be implemented by a CPU (Central Processing Unit) and a program interpreted and executed by the CPU, or may be implemented as hardware based on wired logic. In addition, the program is recorded on a non-transitory computer-readable recording medium containing programmed instructions for causing a computer to execute the method according to the present embodiment, which will be described later, and may be read mechanically by the tactile sense presentation device 100, if necessary. That is, a storage such as a ROM or an HDD (Hard Disk Drive) stores a computer program for issuing commands to the CPU to perform various processes in cooperation with an OS (Operating System). This computer program is executed by being loaded into a RAM and constitutes a controller in cooperation with the CPU.

In addition, this computer program may be stored in an application program server connected to the tactile sense presentation device 100 via an arbitrary network, and all or a part of the computer program may be downloaded as necessary.

In addition, the program according to the present embodiment may be stored in a computer-readable recording medium, or may be configured as a program product. As used herein, the term “recording medium” includes any “portable physical medium” such as a memory card, a USB memory, an SD card, a flexible disk, a magneto-optical disk, a ROM, an EPROM, an EEPROM, a CD-ROM, an MO, a DVD, and a Blu-ray (registered trademark) disk.

In addition, the term “program” refers to a data processing method written in any language or writing method, regardless of a format such as a source code or a binary code. In addition, the term “program” is not necessarily limited to a unitarily constructed program, but may include a distributed program consisting of multiple modules or libraries, or a program that cooperates with a separate program typified by an OS (Operating System) to accomplish a function thereof. Well-known configurations and procedures may be used for a specific configuration for reading the recording medium, a reading procedure, an installation procedure after reading, and the like in respective devices described in the embodiment. The present embodiment may be configured by a program product recorded in a non-transitory computer-readable recording medium.

Various databases and the like stored in the tactile sense presentation device 100 are storage means including memory devices such as a RAM and a ROM, fixed disk devices such as a hard disk and the like, a flexible disk, an optical disk, and the like. The various databases and the like store various programs, tables, databases, web page files, and the like used for various processes and website provision.

In addition, the tactile sense presentation device 100 may be configured as an information processing device such as a known personal computer or workstation, or may be configured by connecting any peripheral device to the information processing device. In addition, the tactile sense presentation device 100 may be implemented by installing software (including programs, data, etc.) that causes the information processing device to implement the method of the present embodiment.

A specific tactile sense presentation program of the present embodiment is as follows.

<17> A tactile sense presentation program for causing a computer to execute: acquiring, as a state of an object, object information related to at least one selected from the group of a position, a direction, a distance, a speed, an acceleration, and urgency; and presenting the state of the object as a tactile stimulus in a pseudo manner based on the object information.

According to <17>, even when it is difficult to convey a surrounding situation visually or aurally, the user can intuitively recognize the surrounding situation by a tactile sense.

In addition, a specific electronic device of the present embodiment is as follows.

<18> An electronic device equipped with the tactile sense presentation device of any one of <1> to <15>.

According to <18>, even when it is difficult to convey a surrounding situation visually or aurally, the use can intuitively recognize the surrounding situation by a tactile sense.

In addition, a specific form of distribution/integration of the devices is not limited to those illustrated in the drawings. All or a part of the devices may be functionally or physically distributed or integrated in arbitrary units according to various additions or functional loads. In other words, the embodiments described above may be arbitrarily combined and implemented, or the embodiments may be implemented selectively.

According to the present disclosure in some embodiments, a user can intuitively recognize a surrounding situation with a tactile sense even when it is difficult to convey the surrounding situation visually or aurally.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A tactile sense presentation device comprising:
an object information acquisition part configured to acquire, as a state of an object, object information related to at least one selected from the group of a position, a direction, a distance, a speed, an acceleration, and urgency; and
a tactile stimulus presentation part configured to present the state of the object as a tactile stimulus in a pseudo manner based on the object information.

2. The tactile sense presentation device of claim 1, wherein the tactile stimulus presentation part is configured to present the state of the object as a tactile stimulus of vibration sense or pressure sense in a pseudo manner by controlling tactile elements, which are arranged in an array, a plane, or a line and configured to present a vibration or a pressure.

3. The tactile sense presentation device of claim 2, wherein the tactile stimulus presentation part is configured to present the direction or the distance of the object in a pseudo manner by positions of controlling the tactile elements.

4. The tactile sense presentation device of claim 2, wherein the tactile stimulus presentation part is configured to present the distance, the urgency, and a relative speed of the object in a pseudo manner by intensity of controlling the tactile elements.

5. The tactile sense presentation device of claim 2, wherein the tactile stimulus presentation part is configured to present the distance, the urgency, and a relative speed of the object in a pseudo manner by a frequency of controlling the tactile elements.

6. The tactile sense presentation device of claim 2, wherein the tactile stimulus presentation part is configured to present the distance, the urgency, and a relative speed of the object in a pseudo manner by moving positions of controlling the tactile elements.

7. The tactile sense presentation device of claim 2, wherein the tactile stimulus presentation part includes at least two selected from the group of: a tactile stimulus presentation part configured to present the direction or the distance of the object in a pseudo manner by positions of controlling the tactile elements; a tactile stimulus presentation part configured to present the distance, the urgency, and a relative speed of the object in a pseudo manner by intensity of controlling the tactile elements; a tactile stimulus presentation part configured to present the distance, the urgency, and the relative speed of the object in a pseudo manner by a frequency of controlling the tactile elements; and a tactile stimulus presentation part configured to present the distance, the urgency, and the relative speed of the object in a pseudo manner by moving positions of controlling the tactile elements.

8. The tactile sense presentation device of claim 2, wherein the tactile stimulus presentation part is configured to set an origin indicating a pseudo position of a user in the array, the plane, or the line on which the tactile elements are arranged, and present the state of the object relative to the position of the user as a control position relative to the origin.

9. The tactile sense presentation device of claim 2, wherein the tactile stimulus presentation part is configured to control, when presenting the urgency, a larger number of tactile elements than in a non-emergency.

10. The tactile sense presentation device of claim 2, wherein one unit of a vibrator of each of the tactile elements has a single piezoelectric body structure or a piezoelectric body array structure.

11. The tactile sense presentation device of claim 2, wherein the tactile stimulus presentation part is configured to perform control of turning vibrators of the tactile elements off when presenting a non-tactile stimulus and turning the vibrators of the tactile elements on when presenting a tactile stimulus, or control of turning the vibrators of the tactile elements on when presenting a non-tactile stimulus and turning the vibrators of the tactile elements off when presenting a tactile stimulus.

12. The tactile sense presentation device of claim 2, wherein the tactile elements are movable protrusions using electromagnetic solenoids.

13. The tactile sense presentation device of claim 12, wherein the tactile stimulus presentation part is configured to perform control of causing the movable protrusions of the tactile elements to retract when presenting a non-tactile stimulus and causing the movable protrusions of the tactile elements to protrude when presenting a tactile stimulus, or control of causing the movable protrusions of the tactile elements to protrude when presenting a non-tactile stimulus and causing the movable protrusions of the tactile elements to retract when presenting a tactile stimulus.

14. The tactile sense presentation device of claim 10, wherein the tactile stimulus presentation part is configured to, during vibration of the array structure, concentrate emitted ultrasonic waves on a central portion by delaying a phase of a vibration waveform in the central portion with respect to a phase of a vibration waveform in a peripheral portion.

15. The tactile sense presentation device of claim 1, wherein the tactile stimulus presentation part is configured to move a location where ultrasonic waves are concentrated, by adjusting a phase relationship between drive waves.

16. A tactile sense presentation method, comprising:
acquiring, as a state of an object, object information related to at least one selected from the group of a position, a direction, a distance, a speed, an acceleration, and urgency; and
presenting the state of the object as a tactile stimulus in a pseudo manner based on the object information.

17. A non-transitory computer-readable recording medium that stores a tactile sense presentation program for causing a computer to execute:
acquiring, as a state of an object, object information related to at least one selected from the group of a position, a direction, a distance, a speed, an acceleration, and urgency; and
presenting the state of the object as a tactile stimulus in a pseudo manner based on the object information.

18. An electronic device equipped with the tactile sense presentation device of claim 1.
